(19) United States
(12) Patent Application Publication
(10) Pub. No.: US 2019/0239630 A1
(43) Pub. Date: Aug. 8, 2019

(54) DENTAL HYGIENE DEVICE

(71) Applicant: Web Dental Design Srl, Ravenna (IT)

(72) Inventor: Carlo Ercolani, Ravenna (IT)

(21) Appl. No.: 16/328,792

(22) PCT Filed: Aug. 30, 2017
(86) PCT No.: PCT/IB2017/055211

§ 371 Date: Feb. 27, 2019

(30) Foreign Application Priority Data
Aug. 31, 2016 (IT) 102016000088564

(51) Int. Cl. A46B 5/04; A46B 9/00

(52) U.S. Cl. CPC A46B 5/04; C08L 75/04; A46B 9/005

(57) ABSTRACT

Device (1) for removing dental deposits and presenting a plurality of cells (11′) interconnected through respective bordering linear elements (14) that define a trabeculated structure (12′) of a thickness definable at will and produced in reticulated polyurethane foam with a base of polyester or polyether.

This invention concerns an instrument for the improvement of dental hygiene. In particular, this invention refers to a tool provided with elements designed to remove deposits from the surface of the teeth in order to improve dental hygiene. More in detail, this invention refers to an abrasive tool designed to remove deposits on the dental surfaces of canines in order to apply detergent substances and disinfectants, and improve their dental hygiene.

### DESCRIPTION OF THE STATE OF THE ART

It is known that the lack of dental hygiene produces a bacterial load in the mouth that can cause inflammation of the gum tissues which, in the most severe cases, can lead to the loss of teeth.

In humans, dental hygiene is achieved by combining the mechanical removal of food residues and the aggregates of germs so tenaciously adherent between them as to form films that adhere to the surface of the teeth (which can cause the formation of tartar in combination with salts of calcium and/or phosphates) using a toothbrush and the detergent action provided by toothpaste.

In the veterinary profession, the problem is more complicated, since animals are not in the habit of attending to their dental hygiene, with the result that bacteria proliferate in their mouths and the loss of their teeth is not a rare occurrence. The problem of the presence of pathogenic germs (bacterial load) associated with an animal's teeth becomes particularly serious when its bite causes laceration of the skin and the bacteria in the animal's mouth and on its teeth find in the bitten zone a particularly receptive environment in which to develop.

For the reasons outlined above, the dental, and thus oral, hygiene of animals becomes particularly worthy of attention when we consider our pets, especially when the animals are allowed to move about freely in our homes when there are children living there, or visitors unfamiliar with the animals and therefore at a greater risk of being bitten.

The study of the problem of the dental pathology of dogs and their behavior during cleaning performed with ordinary toothbrushes has shown that, as it is easy to traumatize their gums inadvertently with this method, especially when there is gum disease, which makes the gingival area particularly sensitive. It becomes clear that those animals that have experienced this type of treatment may consequently be unwilling to allow its repetition, making it impossible to perform preventive treatment and therapy.

Considering the situation as described above, an ideal solution would consist of a device that is practical to use, effective and hygienic for treating both animals and persons unable to care for themselves independently, such as very small children, the elderly, or persons who are temporarily immobilized. Such a device would have to be compatible with the anatomy of the patient, so as to be easily tolerated. It would also have to be so inexpensive that the user would prefer to dispose of it rather than reuse it, for the hygienic reasons described above.

### SUMMARY OF THIS INVENTION

This invention concerns a tool for the improvement of dental hygiene. In particular, this invention refers to a tool provided with elements designed to remove deposits from the surface of the teeth, for the purpose of improving dental hygiene. More in detail, this invention refers to an abrasive tool designed to remove deposits on the dental surfaces of canines in order to apply detergent substances and disinfectants, and improve their dental hygiene.

The purpose of this invention is to realize a device capable of removing dental deposits and that overcomes the problems illustrated above, in a practical and economical manner.

According to this invention, a device with the ability to remove dental deposits is realized, where the main characteristics of the deposit-removing device will be described in at least one of the following claims.

A further purpose of this invention is to develop a tool for dental hygiene provided with a portion of extremity that can be associated with a structure for the removal of dental deposits and which is able to overcome the difficulties illustrated above in a practical and economical manner.

This invention realizes a device for dental hygiene, associated with a portion of extremity containing a structure for the removal of dental deposits, where the main characteristics of said device will be described in at least one of the following claims.

A further purpose of this invention is to realize a glove provided with at least one portion of extremity to which a dental deposit removing device is associated and that is capable of overcoming the difficulties illustrated above in a practical and economical way.

According to this invention, a glove is provided with at least one portion of extremity to which a structure for the removal of dental deposits is associated, where the main characteristics of said glove will be described in at least one of the following claims.

### BRIEF DESCRIPTION OF THE FIGURES

Additional characteristics and advantages of the device for the removal of dental deposits, the tool and the glove incorporating at least one of the findings according to this invention will appear clearer from the following description, which refers to the enclosed figures that illustrate a number of embodiments, without limitation, in which identical or corresponding parts of the device are identified by the same reference numbers, if deemed useful in practical terms. In particular:

FIGS. 1 and 2 are schematic three-dimensional views of a first embodiment of this invention;

FIGS. 3 and 4 illustrate in enlarged scale two embodiments of a detail taken from FIG. 1;

FIGS. 5-8 illustrate additional embodiments of FIGS. 1 and 2; and

FIG. 9 illustrates a particular aspect of a detail of one part taken from FIG. 2.

### DETAILED DESCRIPTION OF THIS INVENTION

In FIG. 3 we have illustrated a rectangular portion of a trabeculated device 1 whose shape and composition are considered ideal for operating in the mouth of animals and humans in order to perform preventive treatment and therapy.

With reference to FIG. 9, the device 1 exhibits a base 120 made from a flexible material and provided with an adhesive face 122 so that the device 1 can be applied to supports shaped according to the needs of use, as will be described more in detail hereafter. This adhesive face 122 is covered by a removable film 123. The face 122 thus functions as an adhesive interface for the device 1 and is produced with an adhesive for bonding compatible with medical and veterinary use. In this connection, the choice of the adhesive may be made for the product ICAMELT 3965/08, suitable for the production of packing materials intended to contain food products and cosmetics without, however, limiting the scope of this invention.

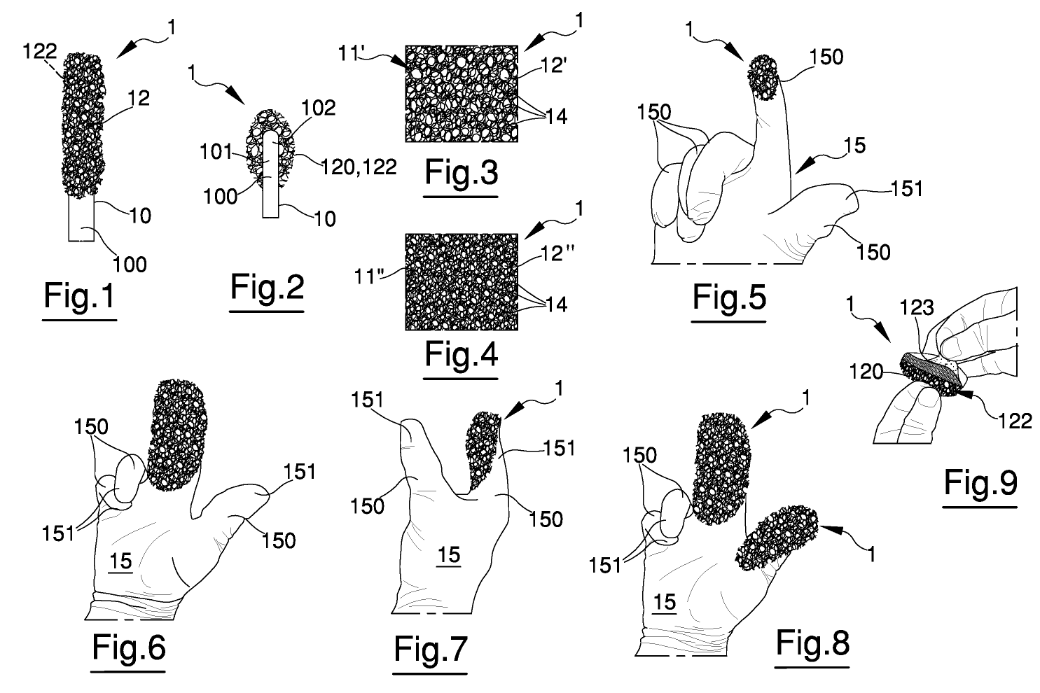

In particular, with reference to FIG. 3, the device 1 presents a plurality of cells 11′ which are connected between them by the respective linear elements 14 of the border to create a trabeculated structure 12 (FIG. 1) the thickness of which can be defined a twill, depending on the layers of cells 11′ which one decides to stack. It is important to note that the linear elements 14 bordering each cell 11′ can be straight or curved, depending on the local density and size of the cells 11′, without this representing a limitation of this invention.

On the other hand, with reference to FIGS. 3 and 4 and for the reason described above, it should also be noted that the linear elements 14 bordering each cell 11′ are arranged randomly, and therefore create a series of peaks and recesses that define a series of adjacent projections distributed at random, which have the ability to perform an abrasive type of actions and thus to remove deposits from the teeth of the patient or animal, and to trap substances within the cells 11′/11″. As can be seen from the comparison of FIGS. 3 and 4, the device 1 may present a network of structures 12′ and 12″, where the density of the cells 11′ and 11″ differs. In particular, the larger the cells 11′/11″ are, the greater is their ability to trap solid substances, while smaller cells 11′/11″ will be better able to trap liquids and substances dissolved in them. The opposite occurs if we consider the abrasive capacity, which decreases with the decreasing size of the cells 11′/11″.

The need to operate in the oral cavity of animals to remove residues of food, bacterial plaque or tartar from the teeth makes it necessary to work in a moist environment, which imposes the need to use a substance capable of remaining stable in the presence of watery substances. For this reason, the choice was made to use a closed-cell polyurethane foam. In addition, it may be useful to point out that if the material used to produce the device 1 is made from polyurethane with a polyester base, the regularity of the distribution of the cells 11′/11″ will be greater; if the polyurethane has a polyether base, the elasticity of the foam network 12′, 12″ could be accentuated.

In addition, the choice of polyurethane makes the device 1 soft so that it does not disturb the surface of the gums, even when inflamed and painful due to gum disease, so that the device 1 is suitable for use in removing bacterial plaque or early formations of tarter from the outer surface of the teeth of canines and other small animals, or even only to apply anti-inflammatory gel or toothpaste for gum massage. It may be useful to add that the material described above deteriorates quickly and is therefore disposable, particularly suited to prevent the transfer of pathogenic agents from one dog to another.

It is easy to see that the combination of these characteristics of the material identified to produce the device 1 makes it possible to establish a functional analogy between the cells 11′/11″ that compose the structures 12′ and 12″ and the bristles of a toothbrush, but that overcome the difficulties caused by the rigidity of the brush handle and the limited hygiene, since normally toothbrushes are not meant to be disposable.

On the other hand, with reference to FIG. 1, the device 1 is applied to a tool 10 for oral hygiene equipped with a stick 100 (more clearly visible in FIG. 2) which has a portion of extremity 101. In FIGS. 1 and 2 the stick 100 is shown with a flattened rectangular cross section.

In particular, as can be seen in FIG. 2, the portion of extremity 101 consists of a rounded head 102 covered with the device 1, without this limiting the scope of the invention. The rounded shape of the head 102 serves to minimize the risk of damaging the gums of the patient on which the tool 10 is used. In addition, it may be useful to point out that the stick 100 presents specific mechanical characteristics such that it may be particularly rigid or flexible depending on the use.

An idea of the ductility of the material and of the effectiveness of the adhesive used to produce any device 1 can be seen by comparing FIG. 1 and FIG. 2, where FIG. 2 shows a device applied to the very tip of the portion of extremity 101 of the stick 100 of the tool 10 and FIG. 1, where the device 1 is shown applied to the stick 100 by simple pressure on the base 120. The adhesive face 122 determines its adhesion to the portion of extremity 101.

The use of the device 1 and the tool 10 are easily understood from what has been described above, and do not require further explanation. However, it would be helpful to point out that every device 1, as it is intrinsically non-toxic, abrasive but unable to cause injuries and is also disposable, will be the obvious choice for the removal by abrasion of plaque and/or tartar from the teeth of humans or animals unable to tolerate the use of toothbrushes, since those substances in the mouth of animals are deposited on wet surfaces. Considering that the device 1 in Filtren® has a trabecular structure, where the linear bordering elements 14 of each cell 11′ are arranged at random, on the one hand, every device 1 will effectively hold, and gradually release under pressure, substances in paste such as toothpaste or disinfectant paste and, on the other, the random orientation of the linear bordering elements 14 imitates and reproduces in a “disposable” device the most recent trend in use among producers of electric toothbrushes to provide heads with bristles oriented at different angles so as to interact with the surfaces of the teeth treated in a broader and at the same time more accurate way, since the bacterial plaque is deposited at random, with the result that it can be removed more effectively. Considering, also, that the cost of this material is minimum, it is clear that the device 1 lends itself particularly well to uses of the disposable type, with the result that the oral hygiene and gum health of pets can be managed at limited cost, both through preventive as well as curative treatment or regular maintenance. In addition, the ability to trap the plaque and possible tartar in the cells of polyurethane as described above, means that the treatment can be done without requiring subsequent rinsing, which animals are not able to do. This is another advantage that makes this product particularly suited for veterinary use, as reported by the illustrious veterinary physician, Dr. Paolo Squarzoni (http://www.kellybrushpet.it/dicono-di-noi/).

After identifying the structural characteristics of the material most suitable for producing the device 1 and the relative material, the inventor observed by chance that these characteristics were available in a product marketed with the name of Filtren® produced by Eurofoam (http://www.eurofoam.de/marken/filtren/).

This product and similar products available on the market are considered “Products ideal for the mechanical and biological filtration of water. It is a non-toxic material used for the filtration of cold water, generally employed in aquariums, for biological filtration through microorganisms fixed in the foam.” According to the website http://www.arefoam.it/wpcontent/uploads/2017/01/ARE_PPI45AZZ.pdf: they have “[. . . ] high resistance to chemical products and UV radiation. The high elasticity makes them adaptable to any shape. Easy to install. The design facilitates the spread of vapor and protects the coverage of roofing against the damage caused by dirt, insects, rain and snow, providing the necessary ventilation and adherence to any shape”, as stated in the website http://firma-dr.pl/en/oferta/universal-gaskets/wedge-gasket-filtren/. Moreover, “The PUR foam is frequently used in daily life. Filters have many uses: filters for the water in pools and aquariums, filters for dust in vacuum cleaners, air and oil filters for cars, truck and motorcycles, filters for air conditioners, etc. To obtain a perfect result of filtration with filters in PUR foam, the dimensions of the cells must be perfectly calibrated”, as stated on the website http://www.multisint.it/it/page/filtro-filtren.html.

The choice of the adhesive ICAMELT 3965/08 to provide the adhesive face 122 of the device 1 cannot be considered a random choice, for the characteristics of suitability for use described above.

Therefore, it should be noted that correct identification the characteristics of the materials which, combined together, serve to embody this invention, requires chemical, biological and odontostomatological expertise, as well as knowledge about aquarium management, all of which are part of the inventor's background, but are not found all together in any specific professional specialty. It will be readily clear that this circumstance proves the discovery of a novel and not obvious idea in the invention described above.

Lastly, it is clear that the device 1 may have different cells 11′/11″ of different densities on the basis of the type of application and type of teeth to be treated for removal of dental deposits. The same reasoning applies to the tool 10. This latter may have different dimensions (length and width of the portion of extremity 101) depending on the need of use on the teeth of a person or animal, for example on children of different ages, women and/or men, as well as animals of different sizes and thus with very different teeth and mouth dimensions.

In any case, it deemed useful to point out that that any alterations made to the device 1 as indicated above, and/or to the tool 10 are within the sphere of protection of this invention and do not change it.

In this connection, it should be noted that in some cases the use of a tool 10 in which the device 1, though very soft and provided with cells 11′/11″ of minimum size, therefore entirely similar to a sponge, both in structural terms and in terms of its mechanical characteristics, is bonded adhesively to a rigid, elongated structure and provided with a handle. A tool of this kind may be perceived as an object that can cause pain in the patient to be treated, especially if the patient suffers from sensitivity of the gums of various origin and, therefore, that performance of the cleaning action may be difficult to carry out and, in some cases, may even be refused due to the inability to support the pain connected with it.

In consideration of the foregoing problem, it will be readily clear that it would be useful to minimize the distance between the operator and the point of application of the device 1, and to minimize the rigidity of the support. In this way, the patient to be treated would feel more that the device 1 is a sort of extension of the operator using it. At the same time, it may be very useful to provide the operator with immediate feedback about the local sensitivity of the patient treated. It will easily be seen that the choice of the material provided with the trabeculated structure 12, with thickness and density of the cells definable at will depending on the type of use, would make it possible to provide the fingers of one hand with at least one device 1 through the respective adhesive face 122. Considering that the fingertips of human hand are provided with a very dense and highly sensitive network of tactile receptors, the operator is able to gain information about the texture of the organic tissues treated, and about their respective conditions, in real time; the fact that the fingertips are intrinsically part of natural tools (the fingers) normally endowed with extreme dexterity, the curative action of removal exercised on the treated zones can be adjusted instantly in terms of location, intensity and frequency of movement. However, taking account of the problems illustrated above concerning the bacterial load that may be particularly heavy in certain mouths, it becomes essential to ensure that there is, between the fingers of one hand and any device 1, a barrier providing total screening, that could be validly achieved with a latex glove, the use of which would also be associated with particular economy such that it would justify single use, according to the logic of “disposable materials” which distinguishes the material used to produce the device 1, traps the tartar and for this reason contains a significant load of pathogenic bacteria after every use.

Therefore, FIGS. 5-8 illustrate several modes of embodiment of this invention in which at least one device is applied to a glove 15 of the disposable type, produced in latex rubber or other material having similar mechanical characteristics and/or functions. In FIGS. 5-8 the number 150 identifies without distinction the fingers of the glove 15 and the number 151 the respective fingertips.

It is easy to understand that using a glove as support for the deposit removing device or devices is a highly practical and effective solution.

Considering the particular versatility of use of the device 1, it may be worthwhile to think of marketing kits for the removal of dental deposits, each of which including at least one device 1, a stick 100 made of substantially rigid material and/or flexible material and/or a glove 15 in latex or a chemically and functionally similar material. The availability of the kit will enable an operator to apply the device 1 from time to time to the stick or to a finger 150 of the glove 15 after removing the film 123 that covers the adhesive face 122 (FIG. 9) to prepare the most appropriate tool for the treatment which has to be carried out on a person or animal.

On the basis of what has been described heretofore, it can easily be seen how every device 1, every support 10 and glove 15 are extremely valid tools for removing dental deposits with great effectiveness in individual animals or humans unable to manage their own oral hygiene, at minimum cost and in total safety for the operator.

1. Device (1) for removing dental deposits, said deposit removing device (1) presenting a plurality of cells (11) interconnected through respective bordering linear elements (14) that define a trabeculated structure (12) of a thickness definable at will, characterized by the fact of being produced in reticulated polyurethane foam with a base of polyester or polyether, or of being produced in Filtren®.

2. Device according to claim 1, characterized by the fact of including a base (120) produced in a flexible material for application to a portion of extremity (101, 102) of any shape.

3. Device according to claim 1, characterized by the fact that said base (120) presents an adhesive external face (122).

4. Tool (10) for dental hygiene provided with a portion of extremity (101, 102); including a device (1) for the removal of dental deposits positioned on said portion of extremity (101, 102) presenting a plurality of cells (11) interconnected through respective bordering linear elements (14) to define a trabeculated structure (12) of a thickness definable at will, characterized by the fact that at least one of said deposit removing device (1) is produced in reticulated polyurethane foam with a base of polyester or polyether, or of being produced in Filtren®.

5. Tool according to claim 4, characterized by the fact that said deposit removing device (1) presents a base (120) produced in flexible material so as to be applicable to a said portion of extremity (101, 102) of any shape.

6. Tool according to claim 5, characterized by the fact that said base (120) presents one adhesive face (122).

7. Tool according to claim 4, characterized by the fact of including a glove (15) and that at least one of said portions of extremity (101) includes a finger (150) of said glove (15).

8. Glove (15) for dental hygiene including at least one device (1) for the removal of dental deposits worn by at least one said respective finger (150); each said deposit removing device (1) presenting a plurality of cells (11) interconnected through respective bordering linear elements (14) to define a trabeculated structure (12) of a thickness definable at will, characterized by the fact that at least one of said deposit removing device (1) is produced in reticulated polyurethane foam with a base of polyester or polyether, or of being produced in Filtren®.

9. Glove according to claim 8, characterized by the fact that said deposit removing device (1) presents a base (120) produced in flexible material to be applicable to a said portion of extremity (100) of any shape.

10. Glove according to claim 9, characterized by the fact that said base (120) presents an adhesive face (122).

11. Glove according to claim 10, characterized by the fact that said adhesive face (122) is produced using bonding glue suitable for the production of packaging designed to contained foods and products for personal use.

12. Glove according to claim 10, characterized by the fact that said adhesive face (122) is produced using blue type ICAMELT 3965/08 or similar.

13. Glove according to claim 8, characterized by the fact of presenting one said deposit removing device (1) on one tip (151) of one said finger (150) and at least one other said deposit removing device (1) on one tip (151) of another said finger (150), to act, in use, on opposite sides of a set of teeth.

14. Glove according to claim 8, characterized by the fact of presenting one said deposit removing device (1) sufficiently broad to cover the width of an adjacent pair of said fingers (150).

15. Kit for removing dental deposits characterized by including a deposit removing device (1) presenting a plurality of cells (11) interconnected through respective bordering linear elements (14) that define a trabeculated structure (12) of a thickness definable at will, characterized by the fact of being produced in reticulated polyurethane foam with a base of polyester or polyether, or of being produced in Filtren®, and a stick (100) of a specific rigidity and/or a glove (15) in latex or other chemically and functionally similar material.
